(19) United States
(12) Patent Application Publication
(10) Pub. No.: US 2019/0155507 A1
(43) Pub. Date: May 23, 2019

(54) METHOD FOR PERFORMING SYSTEM BACKUP IN A MEMORY DEVICE, ASSOCIATED MEMORY DEVICE AND CONTROLLER THEREOF, AND ASSOCIATED ELECTRONIC DEVICE

(71) Applicant: Silicon Motion Inc., Hsinchu County (TW)

(72) Inventors: Chang-Kai Cheng, Hsinchu City (TW); Shen-Ting Chiu, Miaoli County (TW); Jing-Yi Chen, Keelung City (TW)

(21) Appl. No.: 15/948,997

(22) Filed: Apr. 9, 2018

Related U.S. Application Data
(60) Provisional application No. 62/589,523, filed on Nov. 21, 2017.

(51) Int. Cl. G06F 3/06; G06F 12/1009

(52) U.S. Cl. CPC G06F 3/065; G06F 12/1009; G06F 3/0619; G06F 2212/657; G06F 3/0679; G06F 2212/1032; G06F 3/0659

(57) ABSTRACT

A method for performing system backup in a memory device, the associated memory device and the controller thereof, and the associated electronic device are provided. The memory device includes a non-volatile (NV) memory including at least one NV memory element. The method may include: writing system information of the memory device at a plurality of locations within the NV memory to make the system information be stored at a first location and a second location within the plurality of locations, respectively, wherein the system information is internal control information of the memory device, and the system information stored at the second location is equivalent to that stored at the first location; and when the system information stored at the first location is not available, reading the system information stored at the second location to control the memory device to operate according to the system information read from the second location.

### CROSS REFERENCE TO RELATED APPLICATIONS

This application claims the benefit of U.S. provisional application No. 62/589,523, which was filed on Nov. 21, 2017, and is included herein by reference.

### BACKGROUND OF THE INVENTION

### 1. Field of the Invention

The present invention is related to memory control, and more particularly, to a method for performing system backup in a memory device, the associated memory device and the controller thereof, and the associated electronic device.

### 2. Description of the Prior Art

Developments in memory technology have led to the wide application of portable or non-portable memory devices, such as memory cards which conform to the SD/MMC, CF, MS and XD specifications, respectively, or embedded memory devices which conform to the UFS and eMMC specifications, respectively. Improving access control of memories in these memory devices remains an issue to be solved in the art.

NAND flash memories may comprise single level cell (SLC) and multiple level cell (MLC) flash memories. In an SLC flash memory, each transistor used as a memory cell may have any of two electrical charge values, respectively representing the logic values 0 and 1. The storage ability of each transistor used as a memory cell in an MLC flash memory may be fully utilized, where the transistor may be driven by a voltage higher than that in the SLC flash memory, and different voltage levels can be utilized to record information of at least two bits (e.g. 00, 01, 11, or 10). In theory, the recording density of the MLC flash memory may reach at least twice the recording density of the SLC flash memory, and is therefore preferred by manufacturers of NAND flash memories.

Compared with the SLC flash memory, the lower cost and larger capacity of the MLC flash memory means it is more likely to be applied in memory devices. The MLC flash memory does have instability issues, however. To ensure that access control of the flash memory in the memory device meets related specifications, a controller of the flash memory is usually configured to have management mechanisms to properly manage the access of data.

Related art memory devices with the above management mechanisms still have some disadvantages. For example, while the management of accessing the flash memory is complicated, system information of the memory device regarding the management of accessing the flash memory may be stored in the flash memory. Due to some characteristics of the flash memory, writing the system information into the flash memory does not mean the system information is successfully stored in the flash memory. The related art tries to correct the problem, but further problems are introduced. Thus, a novel method and associated architecture are needed for solving the problems without introducing any side effect or in a way that is less likely to introduce a side effect.

### SUMMARY OF THE INVENTION

It is an objective of the present invention to provide a method for performing system backup in a memory device, the associated memory device and the controller thereof, and the associated electronic device, in order to solve the above-mentioned problems.

It is another objective of the present invention to provide a method for performing system backup in a memory device, the associated memory device and the controller thereof, and the associated electronic device, in order to guarantee that the memory device can operate properly in various situations, respectively.

It is yet another objective of the present invention to provide a method for performing system backup in a memory device, the associated memory device and the controller thereof, and the associated electronic device, in order to solve the related art problems without introducing any side effect or in a way that is less likely to introduce a side effect.

At least one embodiment of the present invention provides a method for performing system backup in a memory device. The memory device may comprise a non-volatile (NV) memory, and the NV memory may comprise at least one NV memory element (e.g. one or more NV memory elements). The method may comprise: writing system information of the memory device at a plurality of locations within the NV memory to make the system information be stored at a first location and a second location within the plurality of locations, respectively, wherein the system information is internal control information of the memory device, and the system information stored at the second location is equivalent to the system information stored at the first location; and when the system information stored at the first location is not available, reading the system information stored at the second location to control the memory device to operate according to the system information read from the second location.

In addition to the above method, the present invention also provides a memory device, and the memory device comprises a NV memory and a controller. The NV memory is arranged to store information, wherein the NV memory may comprise at least one NV memory element (e.g. one or more NV memory elements). The controller is coupled to the NV memory, and the controller is arranged to control operations of the memory device. In addition, the controller comprises a processing circuit that is arranged to control the controller according to a plurality of host commands from a host device, to allow the host device to access the NV memory through the controller. For example, the controller writes system information of the memory device at a plurality of locations within the NV memory to make the system information be stored at a first location and a second location within the plurality of locations, respectively, wherein the system information is internal control information of the memory device, and the system information stored at the second location is equivalent to the system information stored at the first location; and when the system information stored at the first location is not available, the controller reads the system information stored at the second location to control the memory device to operate according to the system information read from the second location.

According to some embodiments, an associated electronic device is also provided. The electronic device may comprise the above memory device, and may further comprise: the host device, coupled to the memory device. The host device may comprise: at least one processor, arranged for controlling operations of the host device; and a power supply circuit, coupled to the at least one processor, arranged for providing power to the at least one processor and the memory device. In addition, the memory device may provide the host device with storage space.

In addition to the above method, the present invention also provides a controller of a memory device, where the memory device comprises the controller and a NV memory. The NV memory may comprise at least one NV memory element (e.g. one or more NV memory elements). In addition, the controller comprises a processing circuit that is arranged to control the controller according to a plurality of host commands from a host device, to allow the host device to access the NV memory through the controller. For example, the controller writes system information of the memory device at a plurality of locations within the NV memory to make the system information be stored at a first location and a second location within the plurality of locations, respectively, wherein the system information is internal control information of the memory device, and the system information stored at the second location is equivalent to the system information stored at the first location; and when the system information stored at the first location is not available, the controller reads the system information stored at the second location to control the memory device to operate according to the system information read from the second location.

The present invention method and the associated apparatus (e.g. the processing circuit, the controller, the memory device, etc.) can guarantee that the memory device can operate properly in various situations. For example, when the system information at one of the locations within the NV memory is damaged, it can be obtained from another of the locations within the NV memory, and the memory device will not suffer from malfunction of the memory device. In addition, the present invention method and apparatus provide a robust data access mechanism. Additionally, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a memory device and a host device according to an embodiment of the present invention.

FIG. 2 illustrates a first control scheme of a method for performing system backup in a memory device such as that shown in FIG. 1 according to an embodiment of the present invention.

FIG. 3 illustrates a second control scheme of the method for performing system backup in the memory device according to an embodiment of the present invention.

FIG. 4 illustrates a third control scheme of the method for performing system backup in the memory device according to an embodiment of the present invention.

FIG. 5 illustrates a fourth control scheme of the method for performing system backup in the memory device according to an embodiment of the present invention.

FIG. 6 illustrates a physical block arrangement scheme of the method for performing system backup in the memory device according to an embodiment of the present invention.

FIG. 7 illustrates a physical block arrangement scheme of the method for performing system backup in the memory device according to another embodiment of the present invention.

FIG. 8 illustrates a working flow of the method for performing system backup in the memory device according to an embodiment of the present invention.

### DETAILED DESCRIPTION

### I. The Memory System

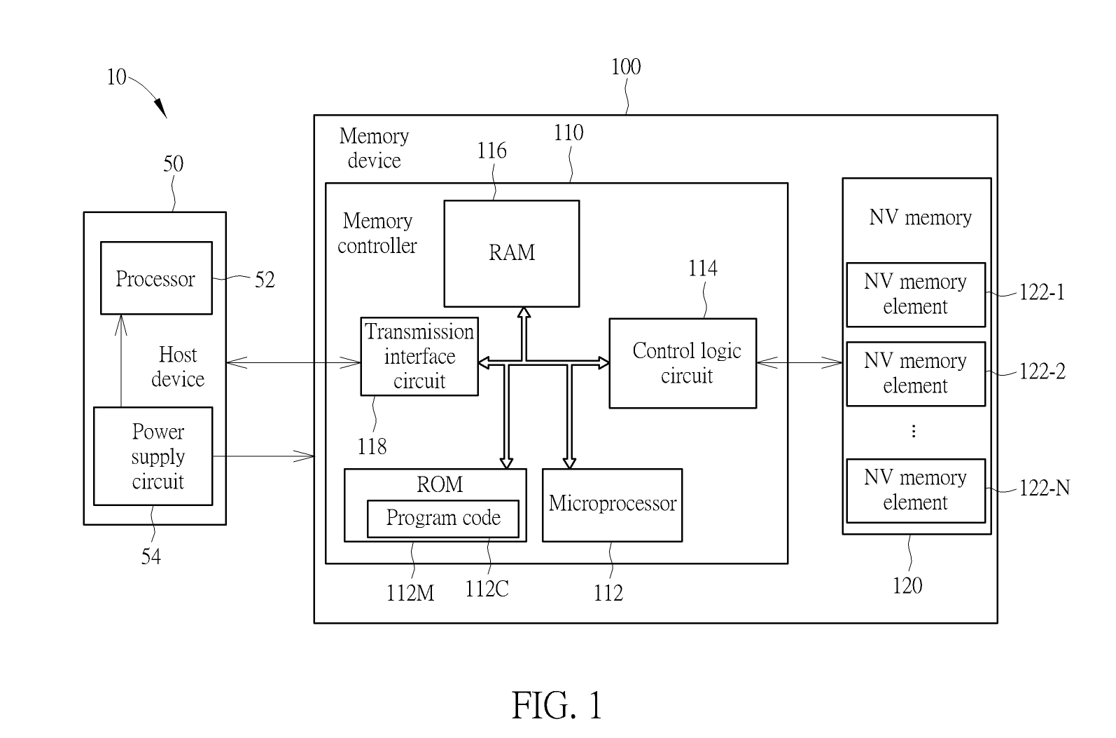

FIG. 1 is a diagram of an electronic device 10 according to an embodiment of the present invention, where the electronic device 10 may comprise a host device 50 and a memory device 100. The host device 50 may comprise at least one processor (e.g. one or more processors) which may be collectively referred to as the processor 52, and may further comprise a power supply circuit 54 that is coupled to the processor 52. The processor 52 is arranged for controlling operations of the host device 50, and the power supply circuit 54 is arranged for providing power to the processor 52 and the memory device 100, and outputting one or more driving voltages to the memory device 100. The memory device 100 may be arranged for providing the host device 50 with storage space, and obtaining the one or more driving voltages from the host device 50 as power source of the memory device 100. Examples of the host device 50 may include, but are not limited to: a multifunctional mobile phone, a wearable device, a tablet computer, and a personal computer such as a desktop computer and a laptop computer. Examples of the memory device 100 may include, but are not limited to: a portable memory device (e.g. a memory card conforming to the SD/MMC, CF, MS or XD specification), a solid state drive (SSD), and various types of embedded memory devices conforming to the UFS and eMMC specifications, respectively. According to this embodiment, the memory device 100 may comprise a controller such as a memory controller 110, and may further comprise a non-volatile (NV) memory 120, where the controller is arranged to control operations of the memory device 100 and access the NV memory 120, and the NV memory 120 is arranged to store information. The NV memory 120 may comprise at least one NV memory element (e.g. one or more NV memory elements), such as a plurality of NV memory elements 122-1, 122-2, . . . , and 122-N, where “N” may represent a positive integer that is greater than one. For example, the NV memory 120 may be a flash memory, and the plurality of NV memory elements 122-1, 122-2, . . . , and 122-N may be a plurality of flash memory chips or a plurality of flash memory dies, but the present invention is not limited thereto.

As shown in FIG. 1, the memory controller 110 may comprise a processing circuit such as a microprocessor 112, a storage unit such as a read-only memory (ROM) 112M, a control logic circuit 114, a random access memory (RAM) 116, and a transmission interface circuit 118, where the above components may be coupled to one another via a bus. The RAM 116 is implemented by a Static RAM (SRAM), but the present invention is not limited thereto. The RAM 116 may be arranged to provide the memory controller 110 with internal storage space. For example, the RAM 116 maybe utilized as a buffer memory for buffering data. In addition, the read-only memory 112M of this embodiment is arranged to store a program code 112C, and the microprocessor 112 is arranged to execute the program code 112C to control the access of the flash memory 120. Note that, in some examples, the program code 112C maybe stored in the RAM 116 or any type of memory. Further, a data protection circuit (not shown) in the control logic circuit 114 may protect data and/or perform error correction, and the transmission interface circuit 118 may conform to a specific communications specification (e.g. the Serial Advanced Technology Attachment (SATA) specification, Universal Serial Bus (USB) specification, Peripheral Component Interconnect Express (PCIE) specification, embedded Multi Media Card (eMMC) specification, or Universal Flash Storage (UFS) specification), and may perform communications according to the specific communications specification.

In this embodiment, the host device 50 may transmit host commands and corresponding logical addresses to the memory controller 110 to access the memory device 100. The memory controller 110 receives the host commands and the logical addresses, and translates the host commands into memory operation commands (which may be simply referred to as operation commands), and further controls the NV memory 120 with the operation commands to perform reading, writing/programing or erasing upon the memory units (e.g. data pages) having physical addresses within the flash memory 120, where the physical addresses correspond to the logical addresses. When the memory controller 110 perform an erase operation on any NV memory element 122-n of the plurality of NV memory elements 122-1, 122-2, . . . , and 122-N (in which “n” may represent any integer in the interval [1, N]), at least one block of multiple blocks of the NV memory element 122-n may be erased, where each block of the blocks may comprise multiple pages (e.g. data pages), and an access operation (e.g. reading or writing) may be performed on one or more pages.

### II. System Protection Mechanism

According to some embodiments, the processing circuit such as the microprocessor 112 may be arranged to control the memory controller 110 according to a plurality of host commands from the host device 50, to allow the host device 50 to access the NV memory 120 through the memory controller 110. The memory controller 110 may store data into the NV memory 120 for the host device 50, read the stored data in response to a host command (e.g. one of the plurality of host commands) from the host device 50, and provide the host device 50 with the data read from the NV memory 120. In order to protect system information (e.g. a system table, etc.) of the memory device 100, such as that related to internal control of the NV memory 120, the memory controller 110 may be designed to write the system information at different locations within the NV memory 120, where the system information may be regarded as internal control information of the memory device 100. For example, a portion of the system information may be related to management of accessing the NV memory 120, but the present invention is not limited thereto. In addition, the memory controller 110 may write the system information at two or more locations within the NV memory 120, respectively, where some control schemes for controlling writing the system information at the two or more locations within the NV memory 120 may be applied. As a result, the system information can be protected.

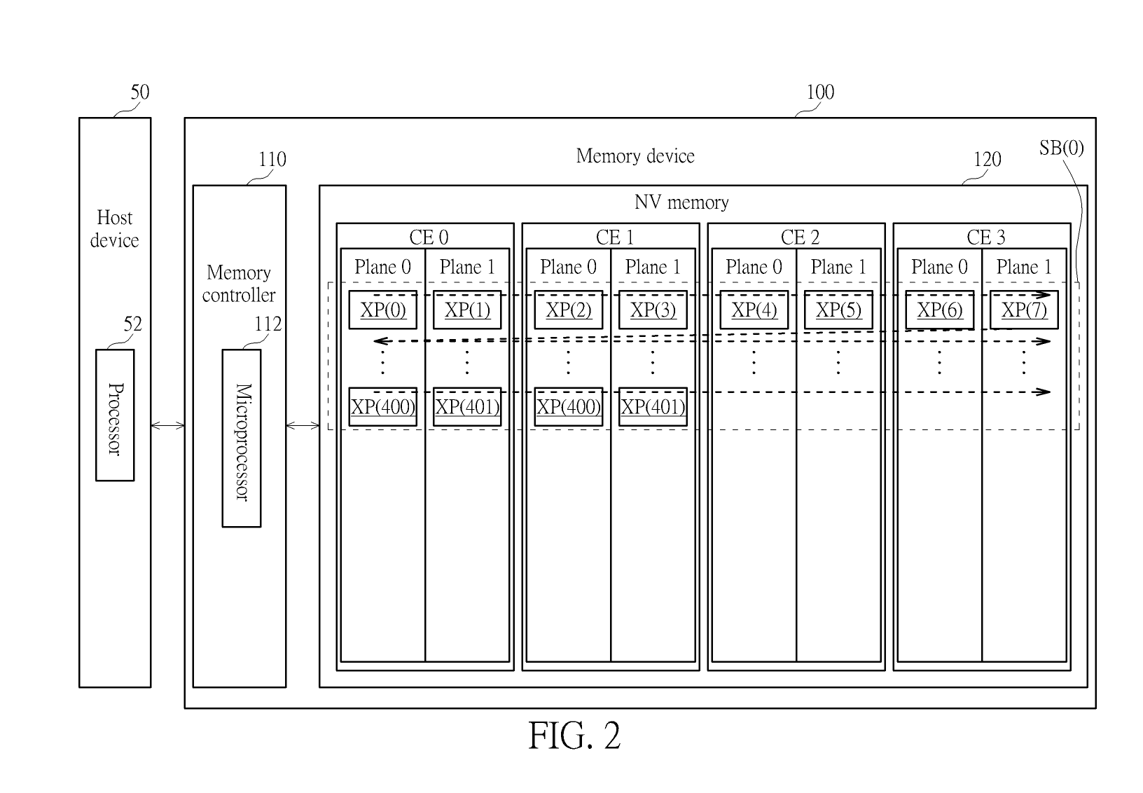

FIG. 2 illustrates a first control scheme of a method for performing system backup in a memory device such as that shown in FIG. 1 according to an embodiment of the present invention. Each of the NV memory elements 122-1, 122-2, . . . , and 122-N in the NV memory 120, such as the aforementioned NV memory element 122-n, may comprise a plurality of physical blocks, and each of the physical blocks may comprise a plurality of physical pages. Under control of the processing circuit such as the microprocessor 112, the memory controller 110 may store a global logical-to-physical (L2P) address mapping table in the NV memory 120, and maintain (e.g. change and/or update) the global L2P address mapping table according to the usage of the NV memory 120. The global L2P address mapping table may comprise a plurality of local L2P address mapping tables, where a local L2P address mapping table may comprise multiple sets of L2P address mapping information (which may be referred to as L2P information, for brevity), and each set of the sets of L2P address mapping information may be utilized for mapping a logical address of a host command to a physical address of the NV memory 120. Additionally, the memory controller 110 may store the system information of the memory device 100 into the NV memory 120, for management of accessing the Flash memory 120. Examples of the system information may include, but are not limited to: a system table regarding overall management of the NV memory 120, and at least one secondary table (e.g. one or more secondary tables) regarding management of the global L2P address mapping table. The aforementioned at least one secondary table may be taken as an example of the portion of the system information that is related to management of accessing the NV memory 120. According to this embodiment, the NV memory elements in the NV memory 120 may be divided into multiple chip-enable (CE) groups such as four CE groups (labeled “CE 0”, “CE 1”, “CE 2”, and “CE 3”, respectively). For example, there may be four NV memory elements respectively corresponding to the four CE groups, and each of the NV memory elements may comprise physical blocks respectively corresponding to multiple planes such as two planes (labeled “Plane 0” and “Plane 1”, respectively), but the present invention is not limited thereto.

As shown in FIG. 2, the memory controller 110 may write the system information into at least one super-block (e.g. one or more super-blocks) of the NV memory 120, such as a super-block SB(0), where each of the aforementioned at least one super-block may comprise multiple physical blocks of the NV memory 120, such as some physical blocks respectively corresponding to the CE groups. The system information may be written as a plurality of system pages, such as the system pages XP(0), XP(1), XP(2), XP(3), XP(4), XP(5), XP(6), XP(7), etc. For example, the system table may comprise two pages of information. The memory controller 110 may write the two pages of information as the system pages XP(400) and XP(401) in the physical blocks of the planes “Plane 0” and “Plane 1” in the CE group “CE 0”, and may write the same two pages of information as the system pages XP(400) and XP(401) in the physical blocks of the planes “Plane 0” and “Plane 1” in the CE group “CE 1”. The memory controller 110 may write other portion(s) of information within the system information (e.g. the secondary table, etc.) into the aforementioned at least one super-block twice when needed. As a result, the system information (e.g. the system table, the secondary table, etc.) can be protected.

According to some embodiments, the number of planes, the number of CE groups, and/or the number of NV memory elements may vary.

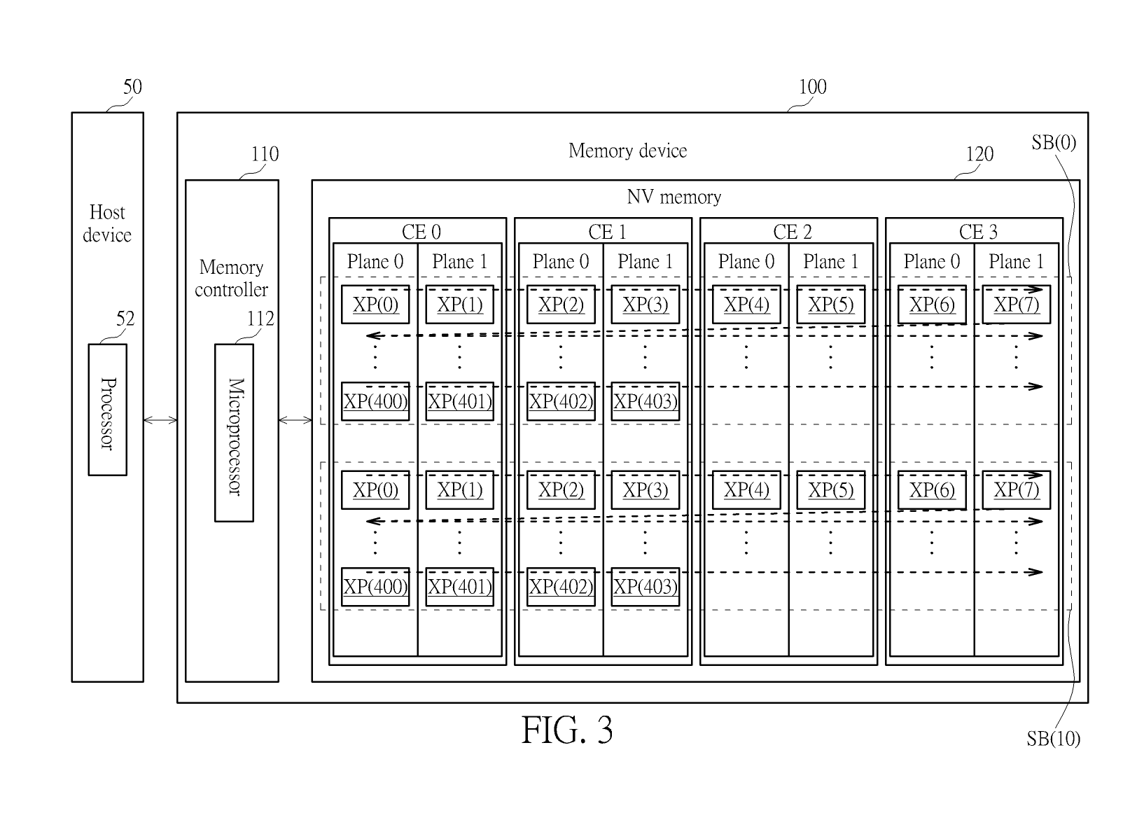

FIG. 3 illustrates a second control scheme of the method for performing system backup in the memory device according to an embodiment of the present invention. In comparison with the embodiment shown in FIG. 2, the memory controller 110 may write the system information (e.g. the system table, the secondary table, etc.) into the aforementioned at least one super-block twice. For example, the memory controller 110 may write the system information into the super-block SB(0) as the system pages XP(0), XP(1), XP(2), XP(3), XP(4), XP(5), XP(6), XP(7), . . . , XP(400), XP(401), XP(402), XP(403), etc. in the super-block SB(0), and may write the same system information into another super-block such as the super-block SB(10) as the system pages XP(0), XP(1), XP(2), XP(3), XP(4), XP(5), XP(6), XP(7), . . . , XP(400), XP(401), XP(402), XP(403), etc. in the super-block SB(10). As a result, the system information (e.g. the system table, the secondary table, etc.) can be protected.

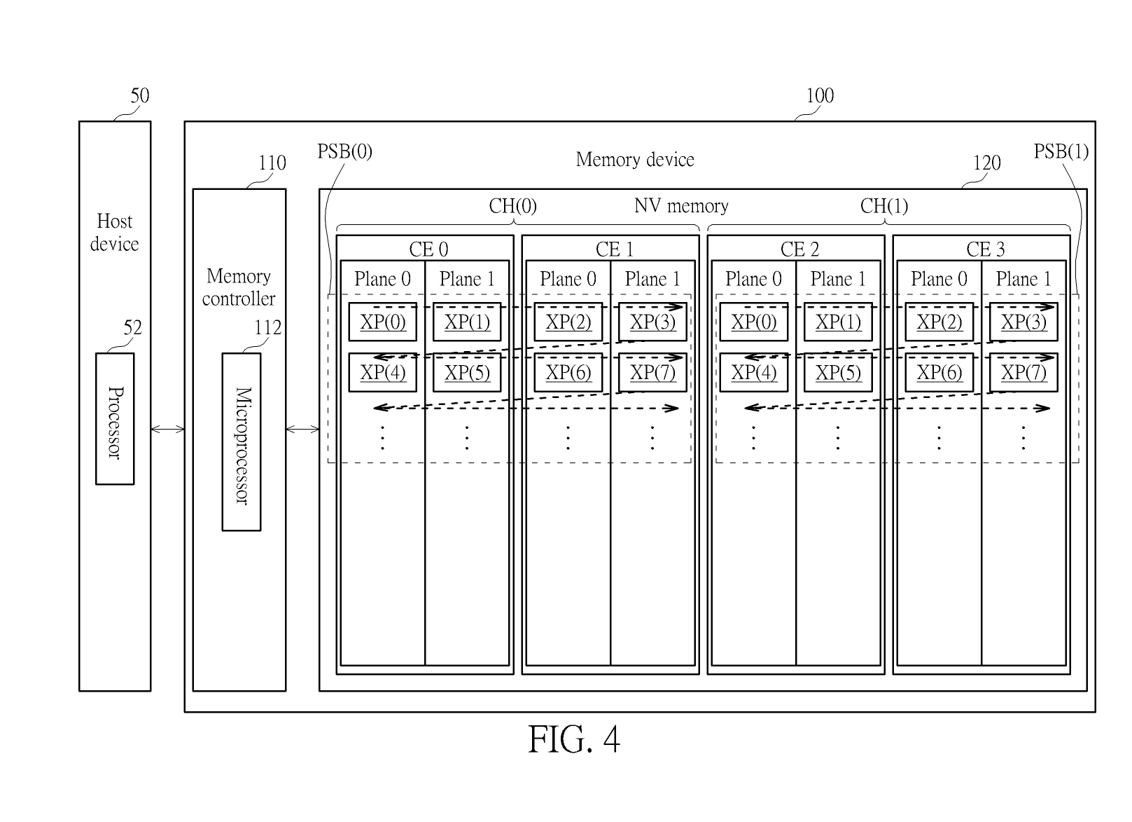

FIG. 4 illustrates a third control scheme of the method for performing system backup in the memory device according to an embodiment of the present invention. In comparison with the embodiment shown in FIG. 2, the memory controller 110 may write the system information (e.g. the system table, the secondary table, etc.) into CE groups respectively corresponding to different channel (e.g. the channels CH(0) and CH(1)) at the same time, for example, in a parallel processing manner, where a super-block may be divided into multiple pseudo-super-blocks (e.g. the pseudo-super-blocks PSB(0) and PSB(1) respectively corresponding to the channels CH(0) and CH(1)). For example, the memory controller 110 may write the system information into the pseudo-super-block PSB (0) on the channel CH(0) as the system pages XP(0), XP(1), XP(2), XP(3), XP(4), XP(5), XP(6), XP(7), etc. in the pseudo-super-block PSB (0) and write the same system information into the pseudo-super-block PSB (1) on the channel CH(1) as the system pages XP(0), XP(1), XP(2), XP(3), XP(4), XP(5), XP(6), XP(7), etc. in the pseudo-super-block PSB(1). As a result, the system information (e.g. the system table, the secondary table, etc.) can be protected.

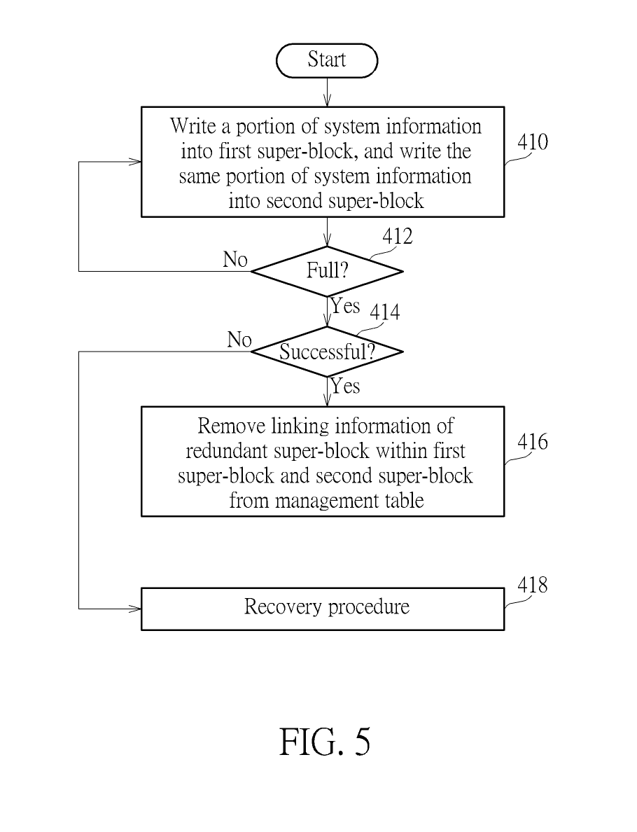

FIG. 5 illustrates a fourth control scheme of the method for performing system backup in the memory device according to an embodiment of the present invention.

In Step 410, the memory controller 110 may write a portion of the system information into a first super-block (e.g. the super-block SB(0)), and write the same portion of the system information into a second super-block (e.g. the super-block SB(10)).

In Step 412, the memory controller 110 may check whether at least one (e.g. one or both) of the first super-block and the second super-block is full. For example, the memory controller 110 may check whether any of the two super-blocks has been written to become full of information, since the memory controller 110 write the same information to each of the two super-blocks. When the aforementioned at least one (e.g. one or both) of the first super-block and the second super-block is full, Step 414 is entered; otherwise, Step 410 is entered, so the memory controller 110 may continue writing.

In Step 414, the memory controller 110 may check whether writing the system information into the NV memory 120 is successful. For example, the memory controller 110 may check whether the system information has been correctly written into any of the two super-blocks, since the memory controller 110 write the same information to each of the two super-blocks. When writing the system information into the NV memory 120 is successful (e.g. the system information has been correctly written into any of the two super-blocks), Step 416 is entered; otherwise, Step 418 is entered.

In Step 416, the memory controller 110 may remove linking information of a redundant super-block within the first super-block and the second super-block from management table(s) of the memory device 100, where whether the linking information of the redundant super-block exists may indicate whether the redundant super-block is used. According to this embodiment, the memory controller 110 may remove (or delete) the linking information to indicate that the redundant super-block becomes non-used (e.g. all information in the redundant super-block becomes invalid), to allow the redundant super-block to be erased in a garbage collection procedure. For example, the system information has been correctly written into the first super-block, and the second super-block maybe regarded as the redundant super-block, no matter whether the system information has been correctly written into the second super-block. In this situation, the memory controller 110 may remove the linking information of the second super-block from the management table(s). For another example, the system information has been correctly written into the second super-block, and the first super-block may be regarded as the redundant super-block, no matter whether the system information has been correctly written into the first super-block. In this situation, the memory controller 110 may remove the linking information of the first super-block from the management table(s). As a result of removing the linking information of the redundant super-block, the memory controller 110 may erase the redundant super-block in the garbage collection procedure, to save storage space of the NV memory 120.

In Step 418, the memory controller 110 may perform one or more operations of a recovery procedure to recover the system information when needed.

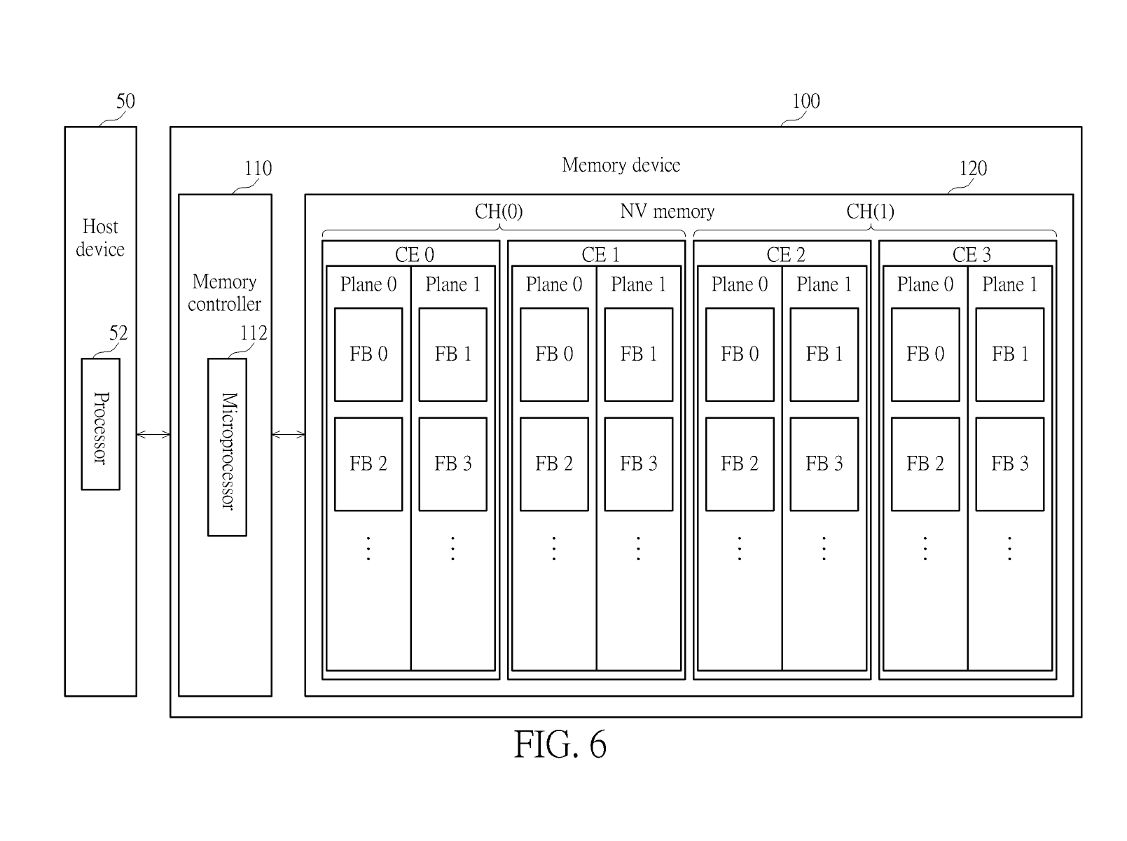

FIG. 6 illustrates a physical block arrangement scheme of the method for performing system backup in the memory device according to an embodiment of the present invention. For example, each of the NV memory elements in a CE group may comprise the physical blocks respectively corresponding to the planes such as the two planes (labeled “Plane 0” and “Plane 1”, respectively), where one of the planes may comprise a portion of physical blocks such as that respectively labeled “FB 0”, “FB 2”, etc., and another of the planes may comprise another portion of physical blocks such as that respectively labeled “FB 1”, “FB 3”, etc., but present invention is not limited thereto.

According to some embodiments (e.g. the embodiment shown in FIG. 4), a pseudo-super-block such as the pseudo-super-block PSB(0) on the channel CH(0) may comprise the first row of physical blocks on the channel CH(0), such as that respectively labeled “FB 0” and “FB 1” on the channel CH(0), and a corresponding pseudo-super-block such as the pseudo-super-block PSB(1) on the channel CH(1) may comprise the first row of physical blocks on the channel CH(1), such as that respectively labeled “FB 0” and “FB 1” on the channel CH(1); the next pseudo-super-block on the channel CH(0) may comprise the second row of physical blocks on the channel CH(0), such as that respectively labeled “FB 2” and “FB 3” on the channel CH(0), and the next pseudo-super-block on the channel CH(1) may comprise the second row of physical blocks on the channel CH(1), such as that respectively labeled “FB 2” and “FB 3” on the channel CH(1); and the rest may be deduced by analogy.

According to some embodiments (e.g. any of the embodiments respectively shown in FIGS. 1, 2, and 4), a super-block such as the super-block SB(0) may comprise the first row of physical blocks such as that respectively labeled “FB 0” and “FB 1”, the next super-block may comprise the second row of physical blocks such as that respectively labeled “FB 2” and “FB 3”, and the rest may be deduced by analogy, where it is unnecessary to implement the channels CH(0), CH(1), etc., but present invention is not limited thereto.

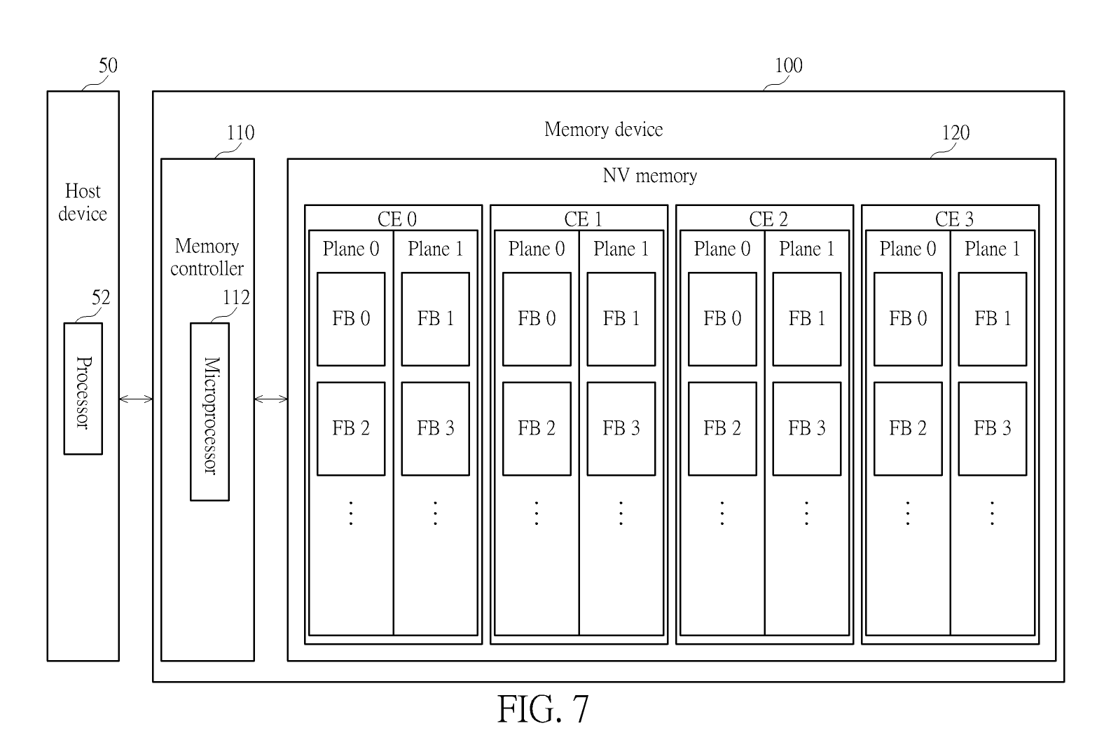

FIG. 7 illustrates a physical block arrangement scheme of the method for performing system backup in the memory device according to another embodiment of the present invention. In comparison with the embodiment shown in FIG. 6, it is unnecessary to implement the channels CH (0), CH (1), etc. in this embodiment. For brevity, similar descriptions for this embodiment are not repeated in detail here.

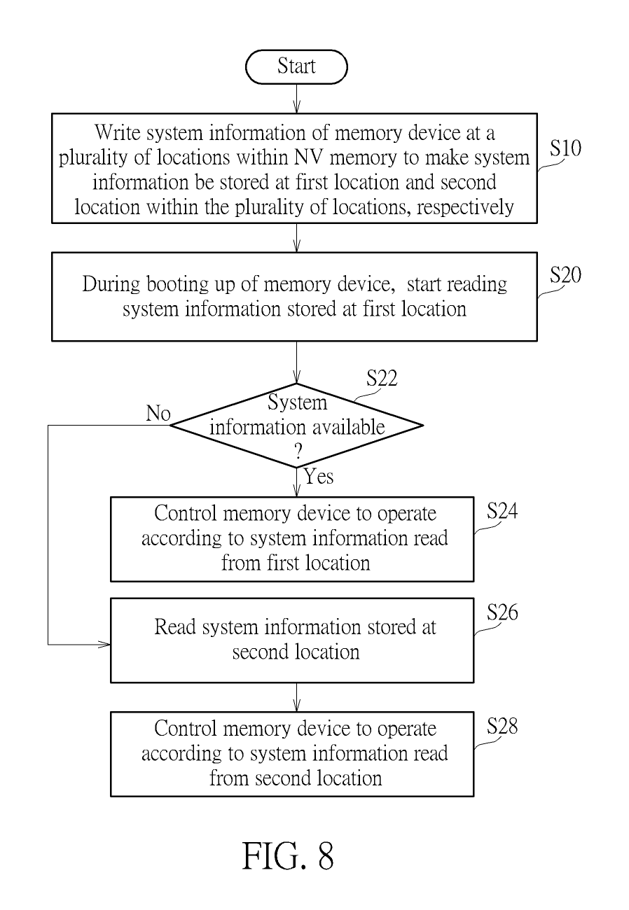

FIG. 8 illustrates a working flow of the method for performing system backup in the memory device according to an embodiment of the present invention. The method can be applied to the electronic device 10, and can be applied to the memory device 100 and the memory controller 110 thereof. For example, under control of the processing circuit such as the microprocessor 112, the memory controller 110 may control operations of the memory device 100 according to the method, and more particularly, according to at least one control scheme (e.g. one or more control schemes) of the method, such as any of the control schemes shown in FIGS. 2-5.

In Step S10, the memory controller 110 may write the system information of the memory device 100 at a plurality of locations within the NV memory 120 to make the system information be stored at a first location and a second location within the plurality of locations, respectively, where the system information is internal control information of the memory device 100, and the system information stored at the second location is equivalent to the system information stored at the first location.

In Step S20, during booting up of the memory device 100, the memory controller 110 may start reading the system information stored at the first location, for performing internal control of the memory device 100. For example, the internal control may comprise initialization of the NV memory 120, management of accessing the NV memory 120, etc., but the present invention is not limited thereto.

In Step S22, the memory controller 110 may check whether the system information stored at the first location is available. When the system information stored at the first location is available, Step S24 is entered; otherwise (e.g. the system information stored at the first location may be damaged or missing, and therefore is not available), Step S26 is entered.

In Step S24, the memory controller 110 may control the memory device 100 to operate according to the system information read from the first location.

In Step S26, the memory controller 110 may read the system information stored at the second location, for performing internal control of the memory device 100. For example, the internal control may comprise initialization of the NV memory 120, management of accessing the NV memory 120, etc., but the present invention is not limited thereto.

In Step S28, the memory controller 110 may control the memory device 100 to operate according to the system information read from the second location.

According to this embodiment, the system information mentioned in Step S10 may comprise the aforementioned system table regarding overall management of the NV memory 120, so the system table may be stored at the first location and the second location, respectively. For example, the system information may further comprise the aforementioned at least one secondary table regarding management of the global L2P address mapping table. In some situations, the system information stored at the first location may be damaged or missing. During booting up of the memory device 100, when the system information stored at the first location is not available, the memory controller 110 may read the system information stored at the second location to control the memory device to operate according to the system information read from the second location.

According to some embodiments (e.g. the embodiment shown in FIG. 2), the first location and the second location may correspond to a first NV memory element and a second NV memory element within the plurality of NV memory elements 122-1, 122-2, . . . , and 122-N, respectively. In addition, a super-block (e.g. the super-block SB(0) shown in FIG. 2) may comprise a set of physical blocks of the first NV memory element and a set of physical blocks of the second NV memory element, and the first location and the second location correspond to the set of physical blocks of the first NV memory element and the set of physical blocks of the second NV memory element, respectively. For example, the set of physical blocks of the first NV memory element may comprise some physical blocks of the NV memory element corresponding to the CE group labeled “CE 0” shown in FIG. 2 (e.g. the physical blocks labeled “FB 0” and “FB 1” in the CE group labeled “CE 0” in a scheme within the physical block arrangement schemes shown in FIGS. 6-7), and the set of physical blocks of the second NV memory element may comprise some physical blocks of the NV memory element corresponding to the CE group labeled “CE 1” shown in FIG. 2 (e.g. the physical blocks labeled “FB 0” and “FB 1” in the CE group labeled “CE 1” in the scheme within the physical block arrangement schemes shown in FIGS. 6-7). In addition, based on a predetermined order of writing into physical blocks of the super-block, the memory controller 110 may write at least one portion (e.g. a portion or all) of the system information into the set of physical blocks of the first NV memory element, and then (for example, when switching from the CE group labeled “CE 0” to the CE group labeled “CE 1”) write the aforementioned at least one portion of the system information into the set of physical blocks of the second NV memory element, where the aforementioned at least one portion may comprise the system table, but the present invention is not limited thereto.

According to some embodiments (e.g. the embodiments respectively shown in FIG. 3 and FIG. 5), the first location and the second location may correspond to a first super-block (e.g. the super-block SB (0) shown in FIG. 3) comprising multiple first sets of physical blocks of the plurality of NV memory elements 122-1, 122-2, . . . , and 122-N and a second super-block (e.g. the super-block SB (10) shown in FIG. 3) comprising multiple second sets of physical blocks of the plurality of NV memory elements 122-1, 122-2, . . . , and 122-N, respectively. For example, the first sets of physical blocks (such as that of the super-block SB (0) shown in FIG. 3) may comprise some physical blocks of the NV memory elements respectively corresponding to the CE groups labeled “CE 0”, “CE 1”, “CE 2”, and “CE 3” shown in FIG. 3 (e.g. the first row of physical blocks labeled “FB 0” and “FB 1” in the CE groups labeled “CE 0”, “CE 1”, “CE 2”, and “CE 3” in a scheme within the physical block arrangement schemes shown in FIGS. 6-7), and the second sets of physical blocks (such as that of the super-block SB (10) shown in FIG . 3) may comprise some subsequent physical blocks of the NV memory elements respectively corresponding to the CE groups labeled “CE 0”, “CE 1”, “CE 2”, and “CE 3” shown in FIG. 3 (e.g. a subsequent row of physical blocks below the first row of physical blocks labeled “FB 0” and “FB 1” in the CE groups labeled “CE 0”, “CE 1”, “CE 2”, and “CE 3” in the scheme within the physical block arrangement schemes shown in FIGS. 6-7). Regarding the control scheme shown in FIG. 3, the memory controller 110 may write the system information into the first sets of physical blocks and then write the system information into the second sets of physical blocks, for example, based on a predetermined order of writing into physical blocks of each of multiple super-blocks within the NV memory 120 that comprise the first super-block and the second super-block, but the present invention is not limited thereto. Regarding the control scheme shown in FIG. 5, the system information may comprise first partial system information, second partial system information, etc. The memory controller 110 may write the first partial system information into a first portion of physical blocks within the first sets of physical blocks and then write the first partial system information into a first portion of physical blocks within the second sets of physical blocks; and the memory controller 110 may write the second partial system information into a second portion of physical blocks within the first sets of physical blocks and then write the second partial system information into a second portion of physical blocks within the second sets of physical blocks. The memory controller 110 may perform similar operations to write subsets of the system information into the first super-block (e.g. the super-block SB(0)) and the second super-block (e.g. the super-block SB(10)), respectively, until at least one (e.g. one or both) of the first super-block and the second super-block is full, but the present invention is not limited thereto. For example, when the first super-block is kept in an open state (e.g. no end-of-block (EOB) information has been written to the first super-block), the memory controller 110 may perform these operations to make a full mapping from the first super-block to the second super-block. When the first super-block is full, the memory controller 110 may write EOB information to the first super-block to close it. As the same subsets of the system information have been written into the second super-block, the second super-block is full, and the memory controller 110 may selectively write EOB information to the second super-block to close it. The memory controller 110 may perform a full check of each of the first super-block and the second super-block. For example, when one of the first super-block and the second super-block is full and writing the system information into the NV memory 120 (more particularly, the one of the first super-block and the second super-block) is successful, the memory controller 110 may remove the linking information of the aforementioned redundant super-block (e.g. the other of the first super-block and the second super-block) from a management table of the memory device 100, such as that for managing the super-blocks, but the present invention is not limited thereto. According to some embodiments, when an error is found in at least one of the first super-block and the second super-block, the memory controller 110 may enter a recovery procedure, to correct the error, collect correct information from the first super-block and the second super-block, and/or make correct information be written in the same super-block (e.g. one of the first super-block and the second super-block, or another super-block).

According to some embodiments (e.g. the embodiment shown in FIG. 4), the plurality of NV memory elements comprises a first set of NV memory elements on a first channel (e.g. the channel CH(0)) and a second set of NV memory elements on a second channel (e.g. the channel CH(1)), and the first location and the second location may correspond to a first pseudo-super-block (e.g. the pseudo-super-block PSB (0)) comprising multiple first sets of physical blocks of the first set of NV memory elements on the first channel and a second pseudo-super-block (e.g. the pseudo-super-block PSB (1)) comprising multiple second sets of physical blocks of the second set of NV memory elements on the second channel, respectively. For example, the first sets of physical blocks (such as that of the pseudo-super-block PSB (0) shown in FIG. 4) may comprise some physical blocks of the NV memory elements respectively corresponding to the CE groups labeled “CE 0” and “CE 1” on the channel CH(0) shown in FIG. 4 (e.g. the physical blocks labeled “FB 0” and “FB 1” in the CE groups labeled “CE 0” and “CE 1” on the channel CH(0) shown in FIG. 6), and the second sets of physical blocks (such as that of the pseudo-super-block PSB(1) shown in FIG. 4) may comprise some physical blocks of the NV memory elements respectively corresponding to the CE groups labeled “CE 2” and “CE 3” on the channel CH(1) shown in FIG. 4 (e.g. the physical blocks labeled “FB 0” and “FB 1” in the CE groups labeled “CE 2” and “CE 3” on the channel CH(1) shown in FIG. 6). In addition, the memory controller 110 may write the system information into the first sets of physical blocks on the first channel and write the system information into the second sets of physical blocks on the second channel, for example, in parallel, but the present invention is not limited thereto.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing system backup in a memory device, the memory device comprising a non-volatile (NV) memory, the NV memory comprising at least one NV memory element, the method comprising:
writing system information of the memory device at a plurality of locations within the NV memory to make the system information be stored at a first location and a second location within the plurality of locations, respectively, wherein the system information is internal control information of the memory device, and the system information stored at the second location is equivalent to the system information stored at the first location; and
when the system information stored at the first location is not available, reading the system information stored at the second location to control the memory device to operate according to the system information read from the second location.

2. The method of claim 1, wherein the system information comprises a system table regarding overall management of the NV memory.

3. The method of claim 2, wherein in addition to the NV memory, the memory device comprises a memory controller; the memory controller stores a global logical-to-physical (L2P) address mapping table in the NV memory, and maintains the global L2P address mapping table according to usage of the NV memory; and
the system information further comprises at least one secondary table regarding management of the global L2P address mapping table.

4. The method of claim 1, wherein the step of reading the system information stored at the second location to control the memory device to operate according to the system information read from the second location further comprises:
during booting up of the memory device, when the system information stored at the first location is not available, reading the system information stored at the second location to control the memory device to operate according to the system information read from the second location.

5. The method of claim 1, wherein the at least one NV memory element comprises a plurality of NV memory elements, and the first location and the second location correspond to a first NV memory element and a second NV memory element within the plurality of NV memory elements, respectively.

6. The method of claim 5, wherein a super-block comprises a set of physical blocks of the first NV memory element and a set of physical blocks of the second NV memory element, and the first location and the second location correspond to the set of physical blocks of the first NV memory element and the set of physical blocks of the second NV memory element, respectively; and the step of writing the system information of the memory device at the plurality of locations within the NV memory to make the system information be stored at the first location and the second location within the plurality of locations respectively further comprises:
writing at least one portion of the system information into the set of physical blocks of the first NV memory element and then writing the at least one portion of the system information into the set of physical blocks of the second NV memory element.

7. The method of claim 1, wherein the at least one NV memory element comprises a plurality of NV memory elements, and the first location and the second location correspond to a first super-block comprising multiple first sets of physical blocks of the plurality of NV memory elements and a second super-block comprising multiple second sets of physical blocks of the plurality of NV memory elements, respectively.

8. The method of claim 7, wherein the step of writing the system information of the memory device at the plurality of locations within the NV memory to make the system information be stored at the first location and the second location within the plurality of locations respectively further comprises:
writing the system information into the first sets of physical blocks and then writing the system information into the second sets of physical blocks.

9. The method of claim 7, wherein the system information comprises first partial system information and second partial system information; and the step of writing the system information of the memory device at the plurality of locations within the NV memory to make the system information be stored at the first location and the second location within the plurality of locations respectively further comprises:
writing the first partial system information into a first portion of physical blocks within the first sets of physical blocks and then writing the first partial system information into a first portion of physical blocks within the second sets of physical blocks; and
writing the second partial system information into a second portion of physical blocks within the first sets of physical blocks and then writing the second partial system information into a second portion of physical blocks within the second sets of physical blocks.

10. The method of claim 9, further comprising:
when at least one of the first super-block and the second super-block is full and writing the system information into the NV memory is successful, removing linking information of a redundant super-block within the first super-block and the second super-block from a management table of the memory device.

11. The method of claim 1, wherein the at least one NV memory element comprises a plurality of NV memory elements, the plurality of NV memory elements comprises a first set of NV memory elements on a first channel and a second set of NV memory elements on a second channel, and the first location and the second location correspond to a first pseudo-super-block comprising multiple first sets of physical blocks of the first set of NV memory elements on the first channel and a second pseudo-super-block comprising multiple second sets of physical blocks of the second set of NV memory elements on the second channel, respectively.

12. The method of claim 11, wherein the step of writing the system information of the memory device at the plurality of locations within the NV memory to make the system information be stored at the first location and the second location within the plurality of locations respectively further comprises:
writing the system information into the first sets of physical blocks on the first channel; and
writing the system information into the second sets of physical blocks on the second channel.

13. The method of claim 12, wherein the system information is written into the first sets of physical blocks on the first channel and written into the second sets of physical blocks on the second channel in parallel.

14. The method of claim 1, wherein a portion of the system information is related to management of accessing the NV memory.

15. A memory device, comprising:
a non-volatile (NV) memory, arranged to store information, wherein the NV memory comprises at least one NV memory element; and
a controller, coupled to the NV memory, arranged to control operations of the memory device, wherein the controller comprises:
a processing circuit, arranged to control the controller according to a plurality of host commands from a host device, to allow the host device to access the NV memory through the controller, wherein:
the controller writes system information of the memory device at a plurality of locations within the NV memory to make the system information be stored at a first location and a second location within the plurality of locations, respectively, wherein the system information is internal control information of the memory device, and the system information stored at the second location is equivalent to the system information stored at the first location; and
when the system information stored at the first location is not available, the controller reads the system information stored at the second location to control the memory device to operate according to the system information read from the second location.

16. The memory device of claim 15, wherein during booting up of the memory device, when the system information stored at the first location is not available, the controller reads the system information stored at the second location to control the memory device to operate according to the system information read from the second location.

17. An electronic device comprising the memory device of claim 15, and further comprising:
the host device, coupled to the memory device, wherein the host device comprises:
at least one processor, arranged for controlling operations of the host device; and
a power supply circuit, coupled to the at least one processor, arranged for providing power to the at least one processor and the memory device;
wherein the memory device provides the host device with storage space.

18. A controller of a memory device, the memory device comprising the controller and a non-volatile (NV) memory, the NV memory comprising at least one NV memory element, the controller comprising:
a processing circuit, arranged to control the controller according to a plurality of host commands from a host device, to allow the host device to access the NV memory through the controller, wherein:
the controller writes system information of the memory device at a plurality of locations within the NV memory to make the system information be stored at a first location and a second location within the plurality of locations, respectively, wherein the system information is internal control information of the memory device, and the system information stored at the second location is equivalent to the system information stored at the first location; and
when the system information stored at the first location is not available, the controller reads the system information stored at the second location to control the memory device to operate according to the system information read from the second location.

19. The controller of claim 18, wherein during booting up of the memory device, when the system information stored at the first location is not available, the controller reads the system information stored at the second location to control the memory device to operate according to the system information read from the second location.

20. The controller of claim 18, wherein a portion of the system information is related to management of accessing the NV memory.
